(19) United States
(12) Patent Application Publication
(10) Pub. No.: US 2018/0255099 A1
(43) Pub. Date: Sep. 6, 2018

(54) SECURITY AND COMPLIANCE ALERTS BASED ON CONTENT, ACTIVITIES, AND METADATA IN CLOUD

(71) Applicant: MICROSOFT TECHNOLOGY LICENSING, LLC, Redmond, WA (US)

(72) Inventors: Binyan Chen, Bellevue, WA (US); Ben Appleby, Issaquah, WA (US); Anupama Janardhan, Bellevue, WA (US); Rui Chen, Redmond, WA (US); Krishna Kumar Parthasarathy, Redmond, WA (US); Suresh C. Palani, Redmond, WA (US); Puhazholi Vetrivel, Redmond, WA (US); Philip K. Newman, Redmond, WA (US); Michael A. Wilde, Bothell, WA (US)

(73) Assignee: MICROSOFT TECHNOLOGY LICENSING, LLC, Redmond, WA (US)

(21) Appl. No.: 15/447,359

(22) Filed: Mar. 2, 2017

(51) Int. Cl. H04L 29/06; H04L 29/08; H04L 12/24; H04L 12/26

(52) U.S. Cl. CPC H04L 63/20; H04L 67/10; H04L 41/06; H04L 41/14; H04L 63/145; H04L 63/1416; H04L 63/1425; H04L 63/1483; H04L 43/16

(57) ABSTRACT

Correlated signals associated with one or more of stored content, content metadata, and activities associated with the stored content of a tenant may be analyzed and alert(s) determined based on alert threshold(s) or broader “abnormal” pattern detection. Different recipients for different alerts or alert levels may be designated and the alert(s) transmitted to the designated recipients. Alerts may also be displayed through an alert management dashboard of a protection service. The alert(s) and the results of the analysis may also be provided to a policy engine for use in adjusting or creating rules within a policy, alert thresholds, and signal collection/analysis. Post-fact investigations may also be initiated upon alerts.

### CROSS-REFERENCE TO RELATED APPLICATION

This application claims the benefit under 35 U.S.C. § 117(e) of U.S. Patent Application No. 62/440,734 filed on Dec. 30, 2016. The U.S. Patent Application is herein incorporated by reference in its entirety.

### BACKGROUND

Hosted services provided by tenants of service providers to their users, such as companies to their employees or organizations to their members, are an increasingly common software usage model. Hosted services cover a wide range of software applications and systems from cloud storage to productivity, and collaboration to communication. Thus, any number of users may utilize applications provided under a hosted service umbrella in generating, processing, storing, and collaborating on documents and other data.

The usage of such hosted services and handling of data may be subject to regulatory, legal, industry, and other rules. Depending on the particular service, handled data, organization type, and many other factors, different rules may be applicable. When policies are implemented for various data types and associated actions, alerts may be issued in response to detected violations or increased risk of violations. However, conventional detection, analysis, and alert approaches are typically mechanistic resulting in misses or false positives. For example, deletion of a high number of files in a tenant's cloud storage may cause an alert, but may not necessarily indicate a threat, whereas deletion of same number of files with a particular type of sensitive data may point to a threat.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to alerts based on content, metadata, and activities in a cloud. In some examples, a plurality of correlated signals associated with one or more of stored content, content metadata, and activities associated with the stored content of a tenant may be analyzed. An alert threshold and one or more designated recipients for an alert may also be determined. Upon determining the alert threshold to be exceeded based on a result of the analysis, the alert may be transmitted to the one or more designated recipients. The alert and the result of the analysis may also be provided to a policy engine for use in adjusting one or more of a policy, the alert threshold, and a signal collection rule.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A through 1C include display diagrams illustrating an example network environment where a system to provide security and compliance alerts based on content, activities, and metadata in cloud may be implemented;

FIG. 2 includes a display diagram illustrating conceptually an example set of actions and components for implementing security and compliance alerts based on content, activities, and metadata in cloud;

FIG. 3 includes a display diagram illustrating example architecture of a system to provide security and compliance alerts based on content, activities, and metadata in cloud;

FIG. 4 includes a display diagram illustrating another example architecture of a system to provide security and compliance alerts based on content, activities, and metadata in cloud;

FIG. 5 includes a display diagram illustrating an example dashboard associated with a service providing security and compliance alerts based on content, activities, and metadata in cloud;

FIG. 6 is a networked environment, where a system according to embodiments may be implemented;

FIG. 7 is a block diagram of an example general purpose computing device, which may be used to provide security and compliance alerts based on content, activities, and metadata in cloud; and

FIG. 8 illustrates a logic flow diagram of a method to provide security and compliance alerts based on content, activities, and metadata in cloud, arranged in accordance with at least some embodiments described herein.

### DETAILED DESCRIPTION

As briefly described above, embodiments are directed to security and compliance alerts based on content, activities, and metadata in cloud. In some examples, correlated signals associated with one or more of stored content, content metadata, and activities associated with the stored content of a tenant may be analyzed and alert(s) determined based on alert threshold(s) or broader “abnormal” pattern detection. Different recipients for different alerts or alert levels may be designated and the alert(s) transmitted to the designated recipients. Alerts may also be displayed through an alert management dashboard of a protection service. The alert(s) and the results of the analysis may also be provided to a policy engine for use in adjusting or creating rules within a policy, alert thresholds, and signal collection/analysis. Post-fact investigations may also be initiated upon alerts.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may, be a computer storage medium readable by a computer system and encoding a computer program that comprises instructions for causing a computer or computing system to perform example process(es). The computer-readable storage medium is a computer-readable memory device. The computer-readable storage medium can for example the implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing security and compliance alerts based on content, activities, and metadata is cloud. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

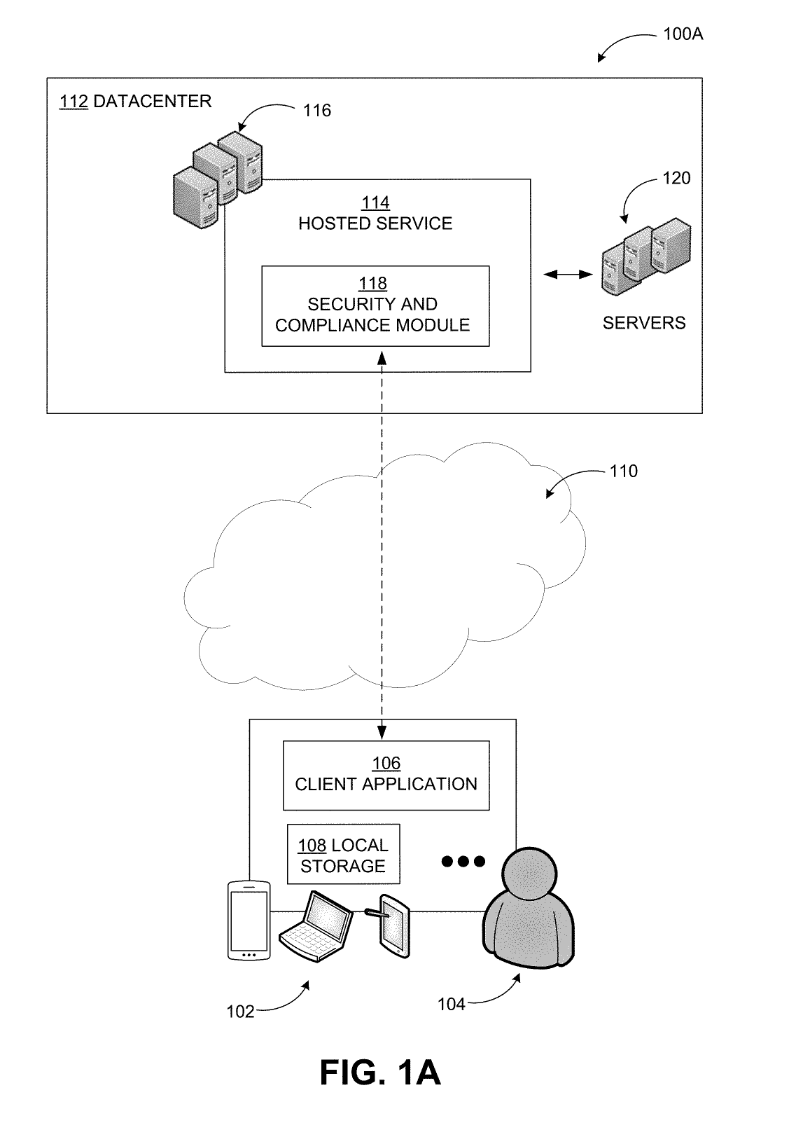

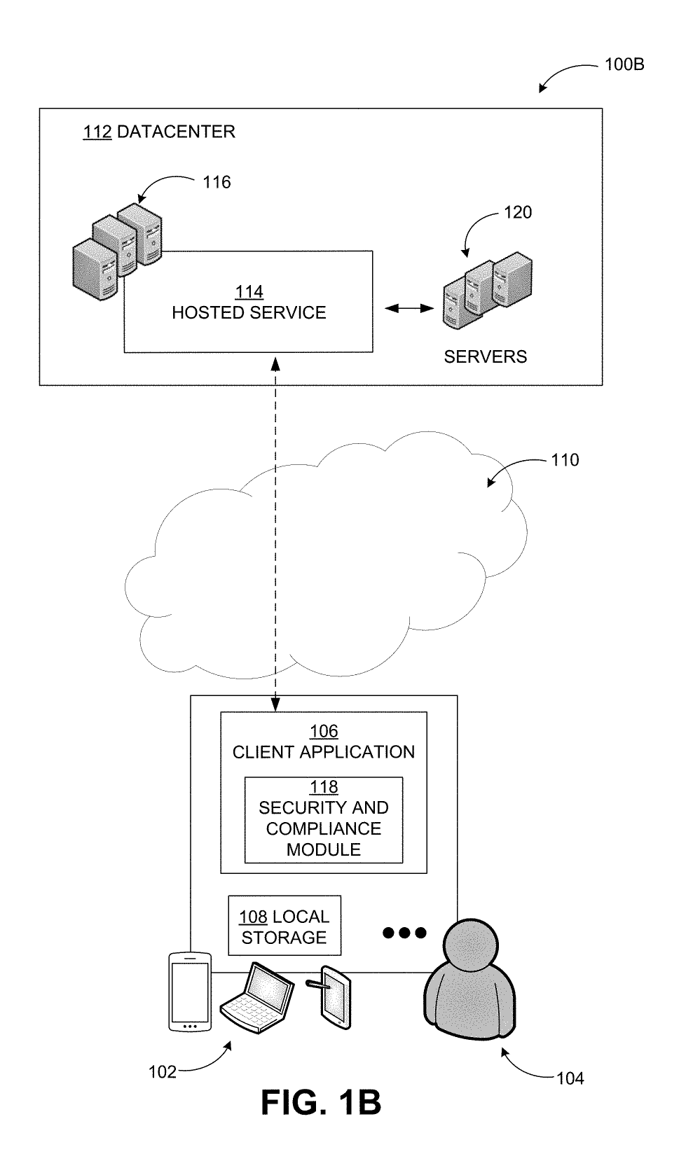

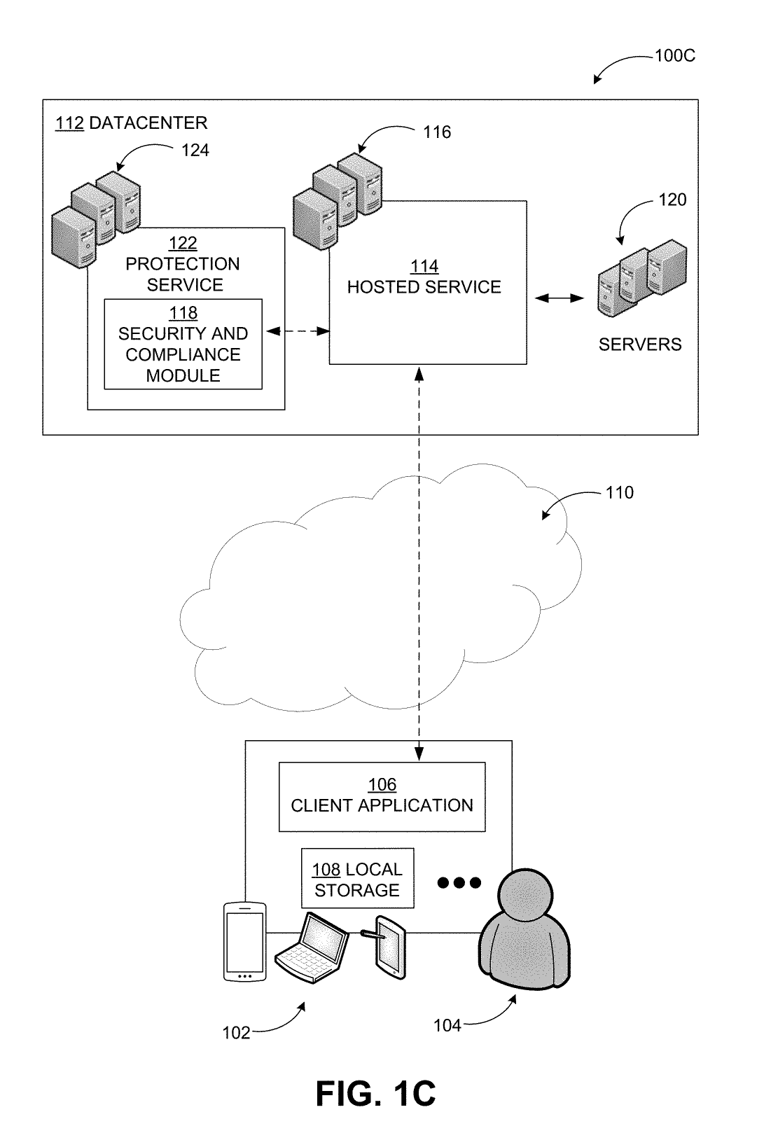

FIGS. 1A through 1C include display diagrams illustrating an example network environment where a system to provide security and compliance alerts based on content, activities, and metadata in cloud may be implemented.

As illustrated in diagrams 100A-100C, an example system may include a datacenter 112 executing a hosted service 114 on at least one processing server 116, which may provide productivity, communication, cloud storage, collaboration, and comparable services to users in conjunction with other servers 120, for example. The hosted service 114 may further include scheduling services, online conferencing services, and comparable ones. The hosted service 114 may be configured to intemperate with a client application 106 through one or more client devices 102 over one or more networks, such as network 110. The client devices 102 may include a desktop computer, a laptop computer, a tablet computer, vehicle-mount computer, a smart phone, or a wearable computing device, among other similar devices. In some examples, the hosted service 114 may allow users to access its services through the client application 106 executed on the client devices 102. In other examples, the hosted service 114 may be provided to a tenant (e.g., a business, an organization, or similar entities), which may configure and manage the services for their users.

In one embodiment, as illustrated in diagram 100A, the processing server 116 may be operable to execute a security and compliance module 118 of the hosted service 114, where the security and compliance module 118 may be integrated with the hosted service 114. In another embodiment, as illustrated in diagram 100B, the client application 106 may be operable to execute the security and compliance module 118, where the security and compliance module 118 may be integrated with the client application 106. In a further embodiment, as illustrated in diagram 100C, the security and compliance module 118 may be integrated with a separate protection service 122 and executed by one or more processing servers 124 of the protection service 122. The protection service>122 may be configured to serve the hosted service 114 and/or multiple applications associated with the hosted service 114, such as the client application 106. Furthermore, the protection service 122 may provide its services to multiple hosted services. Thus, if a tenant subscribes to multiple hosted services, common information analysis results, user profiles, data and metadata) may be used to coordinate suggested policies and configurations reducing duplication of policy implementation burden on the administrators. As described herein, the hosted service 114, the security and compliance module 118, and the protection service 122 may be implemented as software, hardware, or combinations thereof.

The security and compliance module 118 may be configured to manage protection, aspects of the tenant's service environment such as malicious attack mitigation, data governance (e.g., based on legal and regulatory requirements), and policy configuration and enforcement. In one scenario, the security and compliance module 118 of the hosted service 114 may analyze a plurality of correlated signals associated with one or more of stored content, content metadata, and activities associated with the stored content of the tenant. The security and compliance module 118 may also determine an alert threshold and one or more designated recipients for an alert. Upon determining the alert threshold to be exceeded based on a result of the analysis, the security and compliance module 118 may transmit the alert to the one or more designated recipients. The alert and the result of the analysis may also be provided to a policy engine for use in adjusting one or more of a policy, the alert threshold, and a signal collection rule.

Technical advantages of security and compliance alerts based on content, activities, and metadata in cloud may include processing and network capacity preservation, data security enhancement, improvement of usability, and increase of user interactivity.

Embodiments, as described herein, address a need that arises from a very large scale of operations created by software-based services that cannot be managed by humans. The actions/operations described herein are not a mere use of a computer, but address results of a system that is a direct consequence of software used as a service offered in conjunction with a large number of devices and users using hosted services.

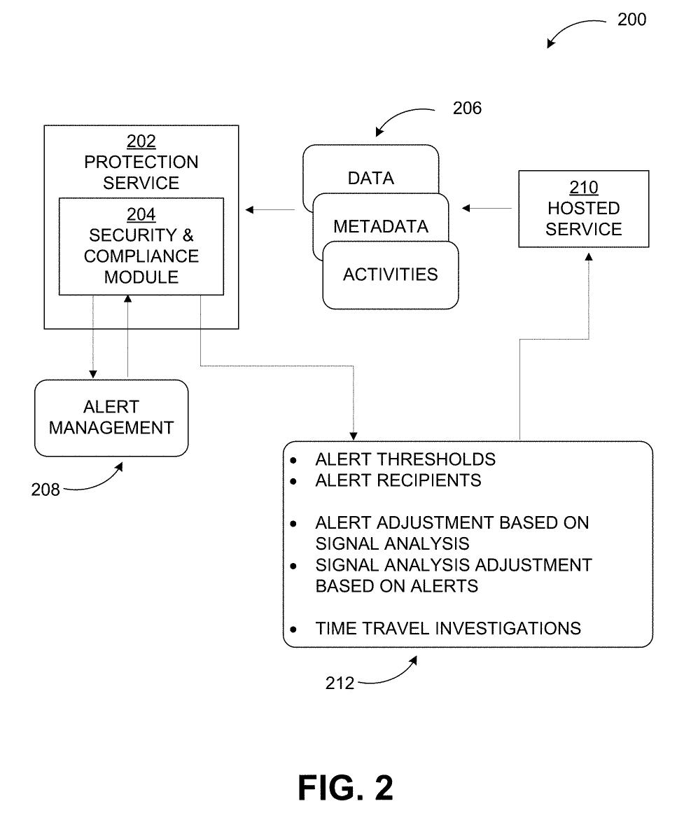

FIG. 2 includes a display diagram illustrating conceptually an example set of actions and components for implementing security and compliance alerts based on content, activities, and metadata in cloud.

As shown in diagram 200, a protection service 202 may retrieve, from a hosted service 210, data, metadata, and activities 206, collectively referred to as signals, associated with the hosted service 210. The protection service 202 may include a security and compliance module 204, which may aggregate and analyze the data, metadata, and activities 206 in order to detect patterns to manage alerts 208 for applicable policies and/or policy configurations based on the patterns. The alerts may be transmitted to designated recipients, displayed on a service dashboard, and used for adjustment of data collection, alert management, and policy management purposes. The security and compliance module 204 may work in conjunction with other modules of the protection service 202 and the hosted service 210 on a number of protection aspects 212. These may include, but are not limited to, determination and adjustment of alert thresholds, designation of alert recipients, alert adjustments based on signal analysis, signal analysis adjustment based on the alerts, and investigations.

The collected signals may include user and admin activities such as delete/share/copy/move actions, anonymous link creation, synchronization, site creation, created exemptions, permission modifications, purging of email boxes, folder movements, user additions, group additions, and similar ones from any application associated with the hosted service 210. Further signals may include phishing and malware threats that arrive at the tenant's environment or are known to circulate globally. File and communication (email, text messages, online conferences, etc.) meta data may be used to determine their legitimacy and whether a file, or communication is infected, spam, or other malware. Content classification and sensitivity (e.g., whether the content includes personal information, healthcare information, financial information, business confidential information, etc.), user sensitivity and risk (user's position within organization, user's potential impact on organization operations, user risk based on credentials or activities), etc. may also be taken into account.

Differently from other services, the protection service 202 and its modules may correlate the different signals and analyze them in context. For example, user activities may not he considered in isolation, but in light of the user's risk level and/or in light of the content or metadata of the content affected by those activities. Thus, a more accurate and granular picture of threat level may be obtained allowing reduced false positives, efficient alert and remedial actions system-wide. The signals may also be weighted based on the analysis factors such as severity of potential impact, activity level, etc.

In some examples, different types of alerts may be designated for different recipients and vice versa. Furthermore, for different thresholds, different recipients may be designated (e.g., a user for a lower threshold on the same signal(s) and an administrator for a higher threshold on the same signal(s)). In other examples, the security and compliance module 204 may work with a policy engine of the protection service to adjust one or more of a policy, the alert threshold, and a signal collection rule. For example, the alert threshold may be adjusted up or down to prevent false positives. A signal collection frequency may be adjusted for increased accuracy or preservation of computing resources. Rules of a policy governing an alert may be adjusted or new rules added.

In some embodiments, pattern detection may be performed on the collected and/or aggregated signals. Usage history, user behaviors, and other patterns may be used to allow less mechanistic alerts such as “an abnormal activity” or “an abnormal behavior” may be defined as opposed to specific threshold based alerts for particular signal types.

In other embodiments, post-fact investigations (also referred to as time travel investigations) may be performed. Some threats (e.g., malware) may be detected after some instances may have been delivered to some users (e.g., via email or saved document). Upon detection, the affected users and their activities, content, etc. may be analyzed and remedial actions (and/or alerts) may be determined based on potential impact, severity, types of content and activities. For example, users who have opened an email with malware may be alerted first, while unopened email containing malware may be deleted or sequestered without even alerting the user. Similarly, affected documents in shared storage may be dealt with first, followed by other, more isolated documents (e.g., in user's local storage).

In other embodiments, alert dashboards, recent alerts widgets, people pages, content pages, correlation based alerts, remediation actions on data in line, an editing alert threshold from user interface, creation of an alert from a policy, and creation of an alert based on triggers for each potential alert scenario (e.g., data deleted), etc. may be allowed through an alert dashboard managed by the protection service 202.

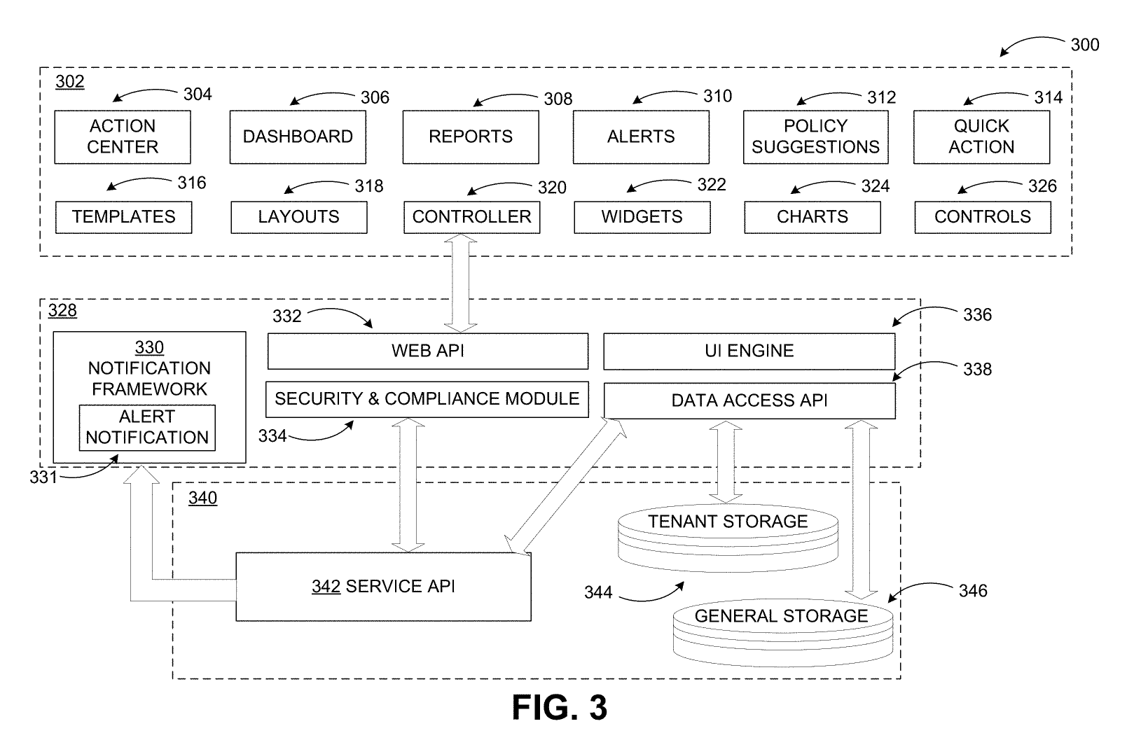

FIG. 3 includes, a display diagram illustrating example architecture of a system to provide security and compliance alerts based on content, activities, and metadata in cloud.

In some examples, a protection service may allow access to its services through a client application 302. The client application 302 may display a user interface enabling a tenant, administrator, or user to interact with an action center 304 associated with protection aspects of a system or organization, such as malicious attack mitigation, data protection, alert management, and policy configuration and enforcement, for example. The user interface may be a dashboard 306 that displays policy suggestions 312 to enhance data protection. The dashboard 306 may also provide reports 308, alerts 310, and quick action options 314 with which the tenant, administrator, or user may interact. The dashboard 306 may have attributes such as templates 316, layouts 318, widgets 322, charts 324 and controls 326 that may be customized.

A dashboard controller 320 may interface with a server 328 through a web application programming interface (API) 332. Calls may be sent back and forth from the server 328 to the client application 302 based on what should be displayed through the dashboard 306. For example, a security and compliance module 334 may generate the policy suggestions 312 and a call may be sent through the web APE 332 to display the policy suggestions 312 in a manner determined by the user interface (UI) engine 336. The server 328 may host a notification framework 330 configured to determine tenants, administrators, and/or users to be notified of policy suggestions, alerts, and reports, among other examples, and how those notifications should be delivered. An alert notification module 331 as part of the notification framework 330 may manage transmission of alerts via email, text message, audio call, video call, etc., as well as display through dashboard 306 or other user interface of the protection service.

A data access API 338 hosted by the server 328 may interface with backend storage systems 340. The backend storage systems 340 may include tenant storage 344 and general storage 346, for example. The backend storage, systems 340 may also include a service API 342 that interfaces with the security and compliance module 334, the notification framework 330, and data that is being retrieved by the data access API 338 from the tenant storage 344 and general storage 346 to allow exchange.

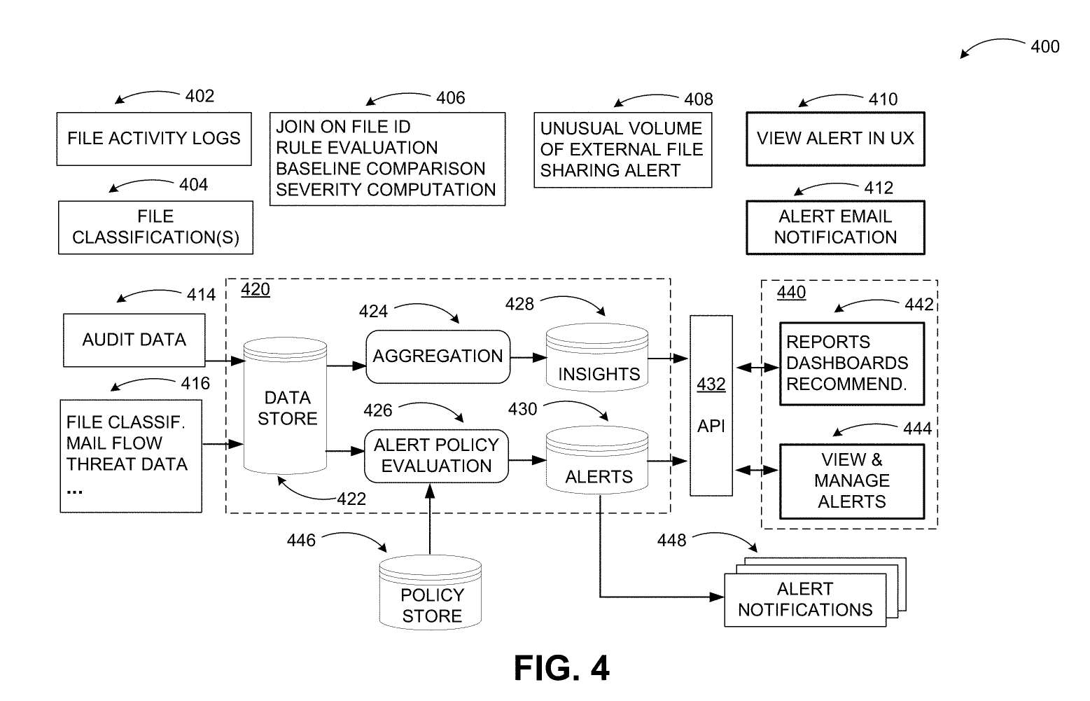

FIG. 4 includes a display diagram illustrating another example architecture of a system to provide security and compliance alerts based on content, activities, and metadata cloud.

Diagram 400 shows the system architecture and some of the actions in an example scenario focusing on stored file related activity. According to the example scenario, file activity logs 402 (delete, modify, copy, move actions, for example) and file classifications 404 (file types, sensitive content, permission levels, etc.) may be used for a number actions 406 such as a join operation (query) on file identifiers, rule evaluation (which rules are applicable, etc.), a baseline comparison, and a severity computation (how severe is the potential impact). For example, an unusual volume of external file sharing alert 408 may be issued if the actions 406 indicate a larger than usual number of files (or files with sensitive content) are being shared externally (across the tenant environment boundaries). The alert may be presented in a protection service user experience 410 and/or entailed 412 to designated recipients.

Audit data 414 (e.g., user activity logs) and other data 416 (e.g., file classifications, mail flow, threat data, etc.) may be used as input to protection service logic 420 and maintained in data store 422. The correlated data may be aggregated 424 and used to generate insights 428 for managing policies, rules, and alerts. An alert policy evaluation 426 may generate alerts 430 based on the evaluated data. Both the insights 428 and alerts 430 may be provided through an application programming interface (API) 432 such as a REST API to a protection renter 440, which may manage and present policies recommendations reports and other information through dashboards 442. The protection center 440 may also manage and present alert dashboards 444 to allow users (e.g., administrators) to view and manage alerts. The alerts 430 may also be used to send alert notifications 448 in form of email, text messages, audio calls, video calls, etc. A policy store 446 may store and provide policies and associated rules to alert policy evaluation 426.

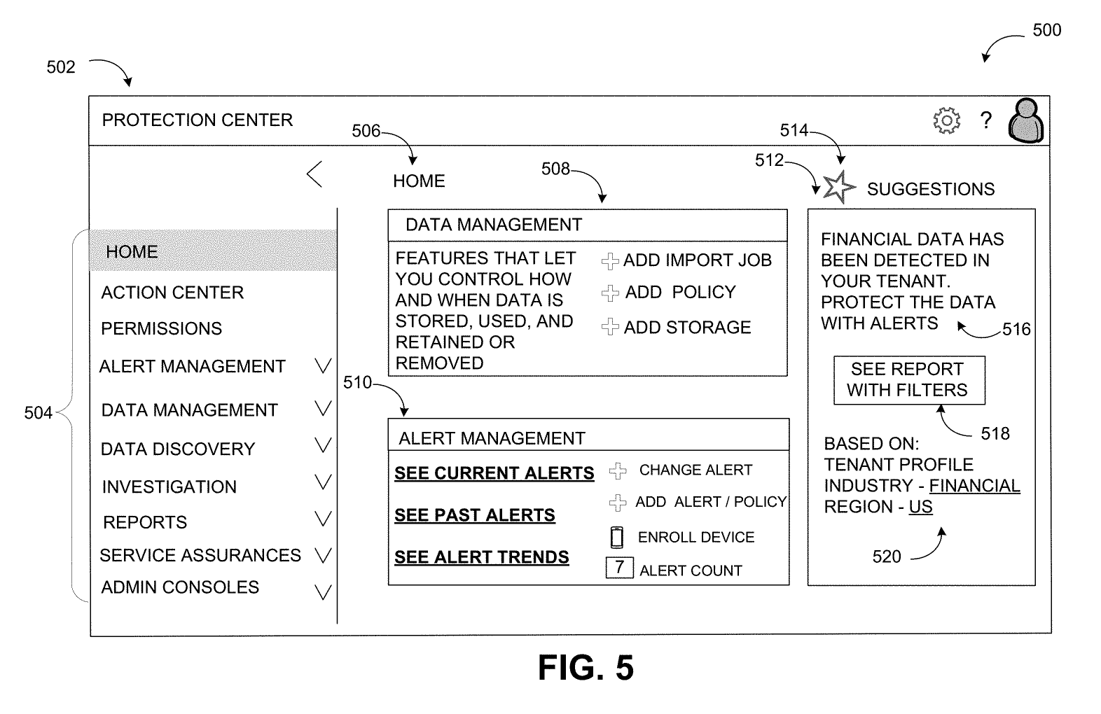

FIG. 5 includes a display diagram illustrating an example dashboard associated with a service providing security and compliance alerts based on content, activities, and metadata in cloud.

As shown in a diagram 500, a client application may provide a tenant, administrator, and/or one or more users of a hosted service access to a user interface, as a dashboard 502, associated with a security and compliance module of the hosted service or a separate protection service. The dashboard 502 may present summary and/or detailed information associated with threats, security and compliance configurations, analyses results, and configuration controls, for example. Among other things, the dashboard 502 may comprise a plurality of tabs 504 that each offer one or more security and compliance-based features that may be managed by the tenant, administrators, and/or users through the dashboard 502. Example tabs 504 may include a home dashboard vie 506, an action center, permissions, alert management, data management data discovery, investigation, reports, service assurances, and administrative consoles.

The home dashboard view 506 may enable the tenant, administrators, and/or users to quickly create, enable, or manage data 508 and alert management 510. Within the alert management group, users may be provided with actions such as viewing current alerts in the system, viewing past alerts, and viewing alert trends. The alert trends may be displayed textually, as well as graphically such as maps, interactive widgets, etc. The alert management 510 may further include an option to change an existing alert, an option to add an alert policy, an option to enroll a device (to receive alerts through the device), and/or an option to view alert counts (e.g., by severity). Additionally, the home dashboard view 506 may display a suggestion user interface element 512 that includes one or more suggested policies. In some examples, an icon 514, such as a star, may be associated with the suggestion user interface element 512 to indicate that a new policy has been suggested since the last time the dashboard 502 was viewed. The suggested policies may be displayed along with analysis results 516 (i.e., results from the analysis of the tenant's service environment).

The suggestion user interface element 512 may also include a control 518 allowing a user to view alert reports with filtering capabilities. For example, one or more reports based on current and/or past alerts may be made available to the user and the user may be enabled to select filters for geographic region, organizational groups, individual users, data type, alert types, and more. In some embodiments, metadata associated with a tenant profile 520 used to tailor the suggested policy may also be displayed in the suggestion user interface element 512. The metadata associated with the tenant profile 520 may include an industry, a size, a geographical location, a hosted service ecosystem, a role, a regulatory requirement, and/or a legal requirement associated with the tenant. For example, the suggested policy may be tailored based on a tenant's affiliation with the financial industry and its location within the United States.

The dashboard 502 is not limited to the above described components and features. Various graphical, textual, coloring, shading, and visual effect schemes may be employed to present suggested policies and/or policy configuration options through a dashboard.

The examples provided in FIGS. 1A through 5 are illustrated with specific systems, services, applications, modules, and displays. Embodiments are not limited to environments, according to these examples. Security and compliance alerts based on content, activities, and metadata in cloud may be implemented in environments employing fewer or additional systems, services, applications, modules, and displays, Furthermore, the example systems, services, applications, modules, and notifications shown in FIG. 1A through 5 may be implemented in a similar manner with other user interface or action flow sequences using the principles described herein.

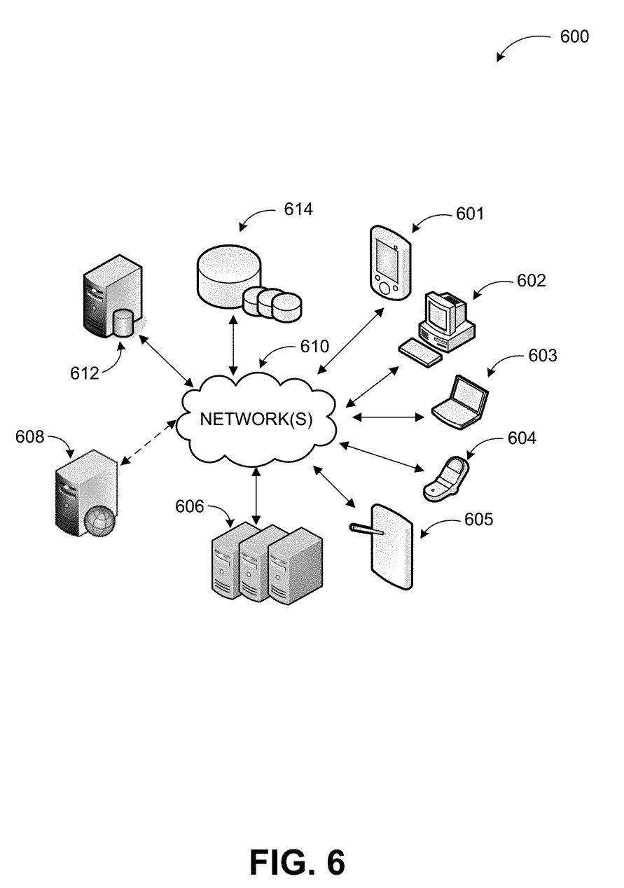

FIG. 6 is a networked environment, where a system according to embodiments may be implemented.

A security and compliance module as described herein may be employed in conjunction with hosted applications and services (for example, the client application 106 associated with the hosted service 114, the hosted service 114, or the protection service 114) that may be implemented via software executed over one or more servers 606 or individual server 608. as illustrated in diagram 600. A hosted service or application may communicate with client applications on individual computing devices such as a handheld computer 601, a desktop computer 602, a laptop computer 606, a smart phone 604, a tablet computer (or slate), 605 (‘client devices’) through network(s) 610 and control a user interface, such as a dashboard, presented to users.

Client devices 601-605 are used to access the functionality provided by the hosted service or client application. One or more of the servers 606 or server 608 may be used to provide a variety of services as discussed above. Relevant data may be stored in one or more data stores (e.g. data store 614), which may be managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed to provide security and compliance alerts based on content, activities, and metadata in cloud. Furthermore, the networked environments discussed in FIG. 6 are for illustration purposes only. Embodiments are not limited to the example applications, engines, or processes.

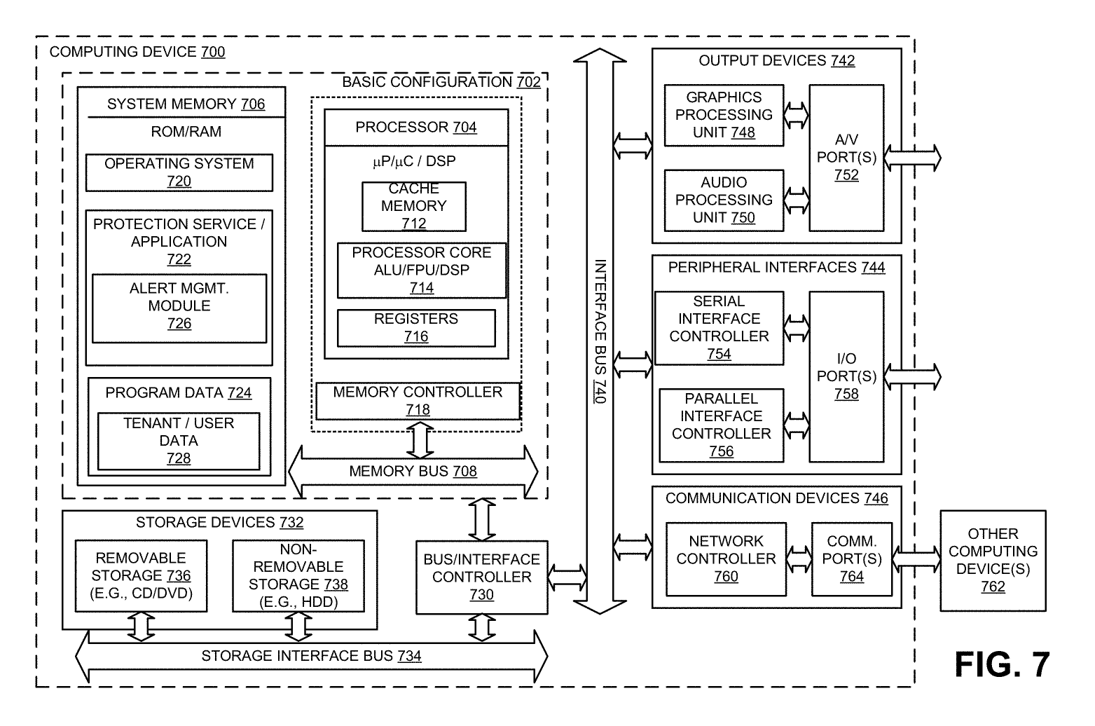

FIG. 7 is a block diagram of an example general purpose computing device, which may be used to provide security and compliance alerts based on content, activities, and metadata in cloud.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG, 7 by those components within the inner dashed line.

Depending on the desired configuration, the processor 704 may be of any type, including but not limited to a microprocessor (μP), a microcontroller (μC), a digital signal processor (DSP) or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a protection application or service 722, and program data 724. The protection application or service 722 may include an alert management module 726, which may be an integrated module of the protection application or service 722. The alert management module 726 may be configured to analyze a plurality of correlated signals associated with one or more of stored content, content metadata, and activities associated with the stored content of a tenant. An alert threshold and one or more designated recipients leis an alert may also be determined. Upon determining the alert threshold to be exceeded based on a result of the analysis, the alert may be transmitted to the one or more designated recipients. The alert and the result of the analysis may also be provided to a policy engine for use in adjusting one or more of a policy, the alert threshold, and a signal collection rule. The program data 724 may include, among other data, tenant user data 728, such as the user information, hosted service information, etc., as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide security and compliance alerts based on content, activities, and metadata air cloud. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be preformed by machines. These human operators need not be collocated with each other, but each can be only with a machine that performs a portion of the program. In other embodiments, the human interaction can be automated such as by pre-selected criteria that may be machine automated.

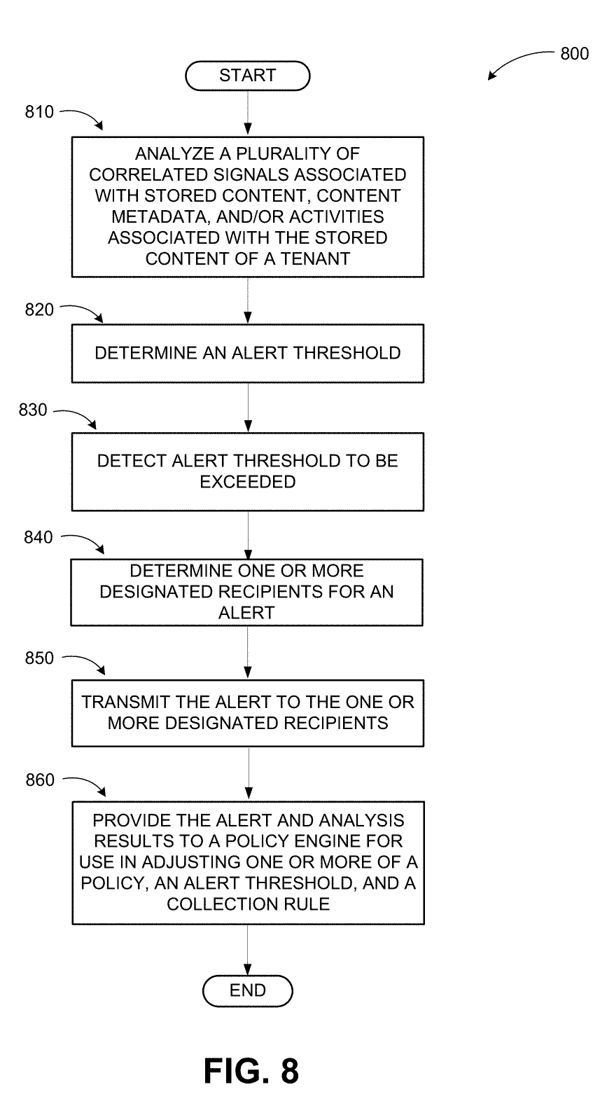

FIG. 8 illustrates a logic flow diagram of a method to provide security and compliance alerts based on content, activities, and metadata in cloud. Process 800 may be implemented on a computing, device, server, or other system. An example server may comprise a communication interface to facilitate, communication between one or more client devices and the server. The example server may also comprise a memory to store instructions, and one or more processors coupled to the memory. The processors, in conjunction with the instructions stored on the memory, may be configured to provide security and compliance alerts based on content, activities, and metadata in cloud.

Process 800 begins with operation 810, where a plurality of correlated signals associated with one or more of stored content, content metadata, and activities associated with the stored content of a tenant may be analyzed. Some examples of analyzed data may include user and admin activities such as delete/share/copy/move actions, anonymous link creation, synchronization, site creation, created exemptions, permission modifications, purging of email boxes, folder movements, user additions, group additions, phishing and malware threats that arrive at the tenant's environment or are known to circulate globally, file and communication (email, text messages, online conferences, etc.) meta data, content classification and sensitivity, user sensitivity and risk, etc.

At operation 820, an alert threshold may be determined based on predefined rules in a policy or dynamically based on one or more of the above-discussed factors. At operation 830, a threshold may be detected as exceeded followed by determination of one or more recipients of an alert at operation 840. For different types of alerts different recipients may be designated. Furthermore, for different thresholds, different recipients may be designated (e.g., a user for a lower threshold on the same signal(s) and an administrator for a higher threshold on the same signal(s)).

The alert may be transmitted to the one or more designated recipients at operation 850. The alert may be transmitted via email, text message, audio call, video call, or similar methods. The alert may also be displayed through a protection service user interface (e.g., alerts dashboard).

At operation 860, the alert and the result of the analysis may also be provided to a policy engine of the protection service for use in adjusting one or more of a policy, the alert threshold, and a signal collection rule. For example, the alert threshold may be adjusted up or down to prevent false positives. A signal collection frequency may be adjusted for increased accuracy or preservation of computing resources. Even rules of a policy governing the alert may be adjusted.

The operations included in process 800 are for illustration purposes. Security and compliance alerts based on content, activities, and metadata in cloud may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing alerts based on content, metadata, and activities in a cloud is described. The means may include a means for analyzing a plurality of correlated signals associated with one or more of stored content, content metadata, and activities associated with the stored content of a tenant; a means for determining an alert threshold; a means for determining, one or more designated recipients for an alert; a means for determining the alert threshold to be exceeded based on a result of the analysis; a means for transmitting the alert to the one or more designated recipients; and a means for providing the alert and the result of the analysis to a policy engine for use in adjusting one or more of a policy, the alert threshold, and a signal collection rule.

According to some examples, a method to provide alerts based on content, metadata, and activities in a cloud is described. The method may include analyzing a plurality of correlated signals associated with one or more of stored content, content metadata, and activities associated with the stored content of a tenant; determining an alert threshold; determining one or more designated recipients for an alert; determining the alert threshold to be exceeded based on a result of the analysis; transmitting the alert to the one or more designated recipients; and providing the alert and the result of the analysis to a policy engine for use in adjusting one or more of a policy, the alert threshold, and a signal collection rule.

According to other examples, the method may also include assigning weights to the plurality of correlated signals. Two or more of the plurality of correlated signals may be correlated and analyzed in context of each other. Determining the alert threshold may include determining the alert threshold based on one or more of a severity of potential impact of a detected threat, a risk level of a user associated with the detected threat, and whether the detected threat has been internalized. The method may further include determining the one or more designated recipients based on an alert type, or determining at least two alert thresholds for an alert type.

According to further examples, the method may also include determining different recipients for the alert type based on the at least two alert thresholds. Determining the alert threshold may include detecting a pattern based on the analysis of the plurality of correlated signals. The pattern may indicate one or more or an abnormal activity, abnormal content, and abnormal content metadata. The method may further include customizing one or more of the alert, the alert threshold, and the one or more recipients based on one or more of an industry, a size, a geographical location, a hosted service ecosystem user role, regulatory requirement, and a legal requirement associated with the tenant.

According to other examples, a server configured to provide alerts based on content, metadata, and activities in a cloud is described. The server may include communication interface configured to facilitate communication between another sever hosting a service, one or more client devices, and the server; a memory configured to store instructions; and one or more processors coupled to the communication interface and the memory and configured to execute a security and compliance module. The security and compliance module may be configured to analyze a plurality of correlated signals associated with one or more of stored content, content metadata, and activities associated with the stored content of a tenant in context of correlation of the signals; determine one or more designated recipients for an alert based on an alert type; determine an alert threshold to be exceeded based on a result of the analysis; transmit the alert to the one or more designated recipients; and provide the alert and the result of the analysis to a policy engine for use in adjusting or creating one or more of a policy, the alert threshold, and a signal collection rule.

According to some examples, the security and compliance module may be further configured to provide an alert management dashboard to be displayed, the alert management dashboard providing options to display current alerts, display recent alerts, display user information, display content information, display correlation information, provide remediation actions, edit alert thresholds, create a new alert from a policy, and create a new alert based on a trigger for a potential alert scenario. The activities associated with the stored content of the tenant may include one or more of a delete action, a share action, a copy action, a move action, an anonymous link creation, a synchronization, a site creation, a created exemption, a permission modification, a purge of email boxes, a folder movement, a user addition, and a group addition.

According to other examples, a signal corresponding to an activity may be analyzed in context of one or more signals corresponding to content or content metadata associated with the activity. The plurality of correlated signals may include signals corresponding to phishing malware threats that have arrived at the service or phishing it malware threats that are known to circulate globally. The plurality of correlated signals may also include signals corresponding to content classification and sensitivity associated with whether stored content includes one or more of personal information, healthcare information, financial information, and business confidential information. The security and compliance module may be configured to transmit the alert through one or more of an email, a text message, an audio call, and a video call.

According to further examples, a system configured to provide alerts based on content, metadata, and activities in a cloud is described. The system may include a first server configured to host a service for a tenant and one or more users, where the service is configured to generate, process, and store content and communications associated with the one or more users; and a second server. The second server may include a communication interface configured to facilitate communication between the first server and the second server; a memory configured to store instructions; and one or more processors coupled to the communication interface and the memory and configured to execute a security and compliance module. The security and compliance module may be configured to analyze a plurality of correlated signals associated with one or more of stored content, content metadata, and activities associated with the stored content of a tenant in context of correlation of the signals; determine one or more designated recipients for an alert based on an alert type; determine one of an abnormal pattern and an alert threshold to be exceeded based on a result of the analysis; transmit the alert to the one or more designated recipients; and provide the alert and the result of the analysis to a policy engine for use in adjusting or creating one or more of a policy, the alert threshold, and a signal collection rule.

According to yet other examples, the security and compliance module may be further configured to determine one of the abnormal pattern and the alert threshold to be exceeded based on a user's sensitivity level and risk level. The user's sensitivity level and risk level may be determined based on one or more of the user's position within an organization, the user's potential impact on one or more organization operations, and the user's activities,

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide alerts based on content, metadata, and activities in a cloud, the method comprising:
analyzing a plurality of correlated related signals associated with one or more of stored content, content metadata, and activities associated with the stored content of a tenant;
determining an alert threshold;
determining one or more designated recipients for an alert;
determining the alert threshold to be exceeded based on a result of the analysis;
transmitting the alert to the one or more designated recipients; and
providing the alert and the result of the analysis to a policy engine for use in adjusting one or more of a policy, the alert threshold, and a signal collection rule.

2. The method of claim 1, further comprising:
assigning weights to the plurality of correlated signals.

3. The method of claim 1, wherein two or more of the plurality of correlated signals are correlated and analyzed in context of each other.

4. The method of claim 1, wherein determining the alert threshold comprises:
determining the alert threshold based on one or more of a severity of potential impact of a detected threat, a risk level of a user associated with the detected threat, and whether the detected threat has been internalized.

5. The method of claim 1, further comprising:
determining the one or more designated recipients based on an alert type.

6. The method of claim 1, further comprising:
determining at least two alert thresholds for an alert type.

7. The method of claim 6, further comprising:
determining different recipients for the alert type based on the at least two alert thresholds.

8. The method of claim 1, wherein determining the alert threshold comprises:
detecting a pattern based on the analysis of the plurality of correlated signals.

9. The method of claim 8, wherein the pattern indicates one or more or an abnormal activity, abnormal content, and abnormal content metadata.

10. The method of claim 1, further comprising:
customizing one or more of the alert, the alert threshold, and the one or more recipients based on one or more of an industry, a size, a geographical location, a hosted service ecosystem, a user role, a regulatory requirement, and a legal requirement associated with the tenant.

11. A server configured to provide alerts based on content, metadata, and activities in a cloud, the server comprising:
a communication interface configured to facilitate communication between another server hosting a service, one or more client devices, and the server;
a memory configured to store instructions; and
one or more processors coupled to the communication interface and the memory and configured to execute a security and compliance module, wherein the security and compliance module is configured to:
analyze a plurality of correlated signals associated with one or more of stored content, content metadata, and activities associated with the stored content of a tenant in context of correlation of the signals;
determine one or more designated recipients for an alert based on an alert type;
determine an alert threshold to be exceeded based on a result of the analysis;
transmit the alert to the one or more designated recipients; and
provide the alert and the result of the analysis to a policy engine for use in adjusting or creating one or more of a policy, the alert threshold, and a signal collection rule.

12. The serer of claim wherein the security and compliance module is further configured to:
provide an alert management dashboard to be displayed, the alert management dashboard providing options to display current alerts, display recent alerts, display user information, display content information, display correlation information, provide remediation actions, edit alert thresholds, create a new alert from a policy, and create a new alert based on a trigger for a potential alert scenario.

13. The server of claim 11, wherein the activities associated with the stored content of the tenant include one or more of a delete action, a share action, a copy action, a move action, an anonymous link creation, a synchronization, a site creation, a created exemption, a permission modification, a purge of email boxes, a folder movement, a user addition, and a group addition.

14. The server of claim 13, wherein a signal corresponding to an activity is analyzed in context of one or more signals corresponding to content or content metadata associated with the activity.

15. The server of claim 11, wherein the plurality of correlated signals include signals corresponding to phishing or malware threats that have arrived at the service or phishing or malware threats that are known to circulate globally.

16. The server of claim 11, wherein the plurality of correlated signals include signals corresponding to content classification and sensitivity associated with whether stored content includes one or more of personal information, healthcare information, financial information, and business confidential information.

17. The server of claim 11, wherein the security and compliance module is configured to transmit the alert through one or more of an email, a text message, an audio call, and a video call.

18. A system configured to provide alerts based on content, metadata, and activities in a cloud, the system comprising:
a first server configured to host a service for a tenant and one or more users, wherein the service is configured to generate, process, and store content and communications associated with the one or more users; and
a second server, comprising:
a communication interface configured to facilitate communication between the first server and the second server;
a memory configured to store instructions; and
one or more processors coupled to the communication interface and the memory and configured to execute a security and compliance module, wherein the security and compliance module is configured to:
analyze a plurality of correlated signals associated with one or more of stored content, content metadata, and activities associated with the stored content of a tenant in context of correlation of the signals;
determine one or more designated recipients for an alert based on an alert type;
determine one of an abnormal pattern and an alert threshold to be exceeded based on a result of the analysis;
transmit the alert to the one or more designated recipients; and
provide the alert and the result of the analysis to a policy engine for use in adjusting or creating one or more of a policy, the alert threshold, and a signal collection rule.

19. The system of claim 18, wherein the security and compliance module is further configured to determine one of the abnormal pattern and the alert threshold to be exceeded based on a user's sensitivity level and risk level.

20. The system of claim 19, wherein the user's sensitivity level and risk level are determined based on one or more of the user's position within an organization, the user's potential impact on one or more organization operations, and the user's activities.
